(19) United States
(12) Patent Application Publication
(10) Pub. No.: US 2025/0375824 A1
(43) Pub. Date: Dec. 11, 2025

(54) Lita's Holesaw Boots

(71) Applicant: Carlita Renee Smith, Annapolis, MD (US)

(72) Inventor: Carlita Renee Smith, Annapolis, MD (US)

(21) Appl. No.: 19/091,579

(22) Filed: Mar. 26, 2025

Related U.S. Application Data
(60) Provisional application No. 63/658,726, filed on Jun. 11, 2024.

(51) Int. Cl. B23B 51/04

(52) U.S. Cl. CPC B23B 51/0473

(57) ABSTRACT

An adjustable step bit for use with multiple hole saws of various sizes. The device comprises a plurality of hole saws and a plurality of hole saw boots. Starting from the distal end, the first hole saw is smaller than the second hole saw, and the second hole saw is smaller than the third hole saw. Each hole saw boot is sized to fit firmly onto a corresponding hole saw. When fully assembled, the device can be attached to the mandrel of a power tool, capable of drilling a series of holes into a structure in step increments. The flexible material of the boot enables the first hole saw to slide firmly into place, which in turn, allows the user to drill a pilot hole without any wobble. This arrangement extends the lifespan of the device but also reduces the need for frequent replacements.

### FIELD OF THE INVENTION

The present invention relates generally to construction tools. More specifically, the present invention is a device that secures multiple hole saws of various sizes together to adjust the hole diameter in step increments.

### BACKGROUND OF THE INVENTION

For years, electricians have faced the frustration of using various sized hole saws, which have limitations and lack versatility. Not to mention the cost and portability issues. Traditional hole saws often require separate purchases for different sizes, leading to unnecessary expenses.

The present invention is applied to a standard size hole saw to improve efficiency and increase productivity at a fraction of the cost. With the present invention, a single kit containing a range of hole saw sizes and arbors is all you need, saving both money and storage space. This innovation will revolutionize the way electricians approach hole drilling tasks. Its affordability, efficiency, and replaceable components make it an invaluable addition to any toolkit.

### BRIEF DESCRIPTION OF THE DRAWINGS

FIG. 1 is a top-front perspective exploded view of the present invention, shown without the hole saws.

FIG. 2 is a top-front perspective exploded view of the present invention, shown with the hole saws.

FIG. 3 is a top-front perspective view of the present invention, shown fully assembled.

FIG. 4 is a top-front perspective view of the hole saw boot of the present invention.

FIG. 5 is a bottom-front perspective view of the hole saw boot of the present invention.

FIG. 6 is a front elevational view of the hole saw boot of the present invention.

FIG. 7 is a top plan view of the hole saw boot of the present invention.

FIG. 8 is a bottom plan view of the hole saw boot of the present invention.

### DETAIL DESCRIPTIONS OF THE INVENTION

All illustrations of the drawings are for the purpose of describing selected versions of the present invention and are not intended to limit the scope of the present invention.

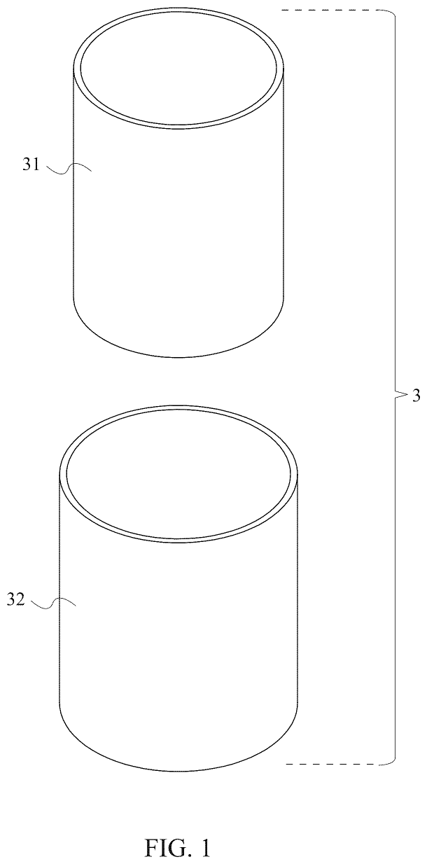

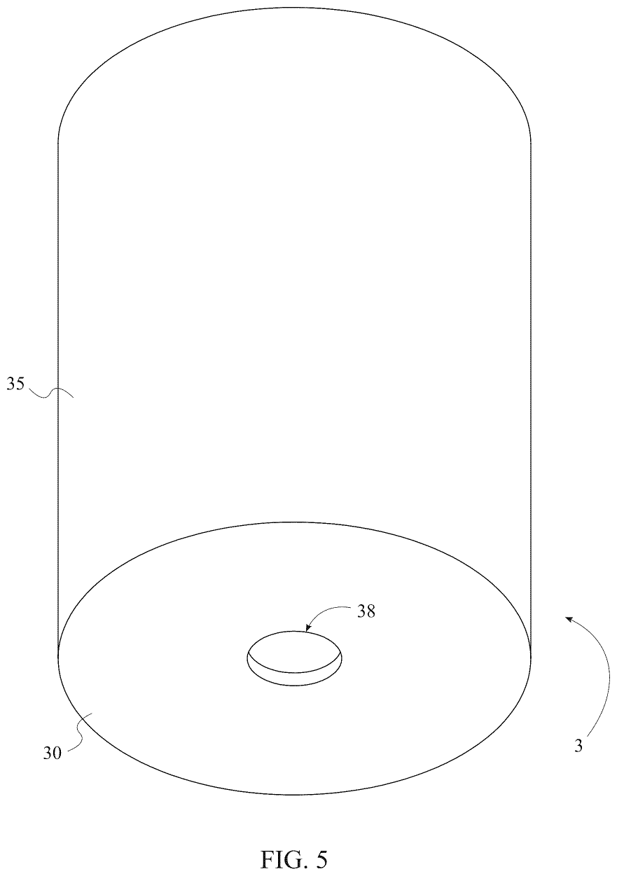

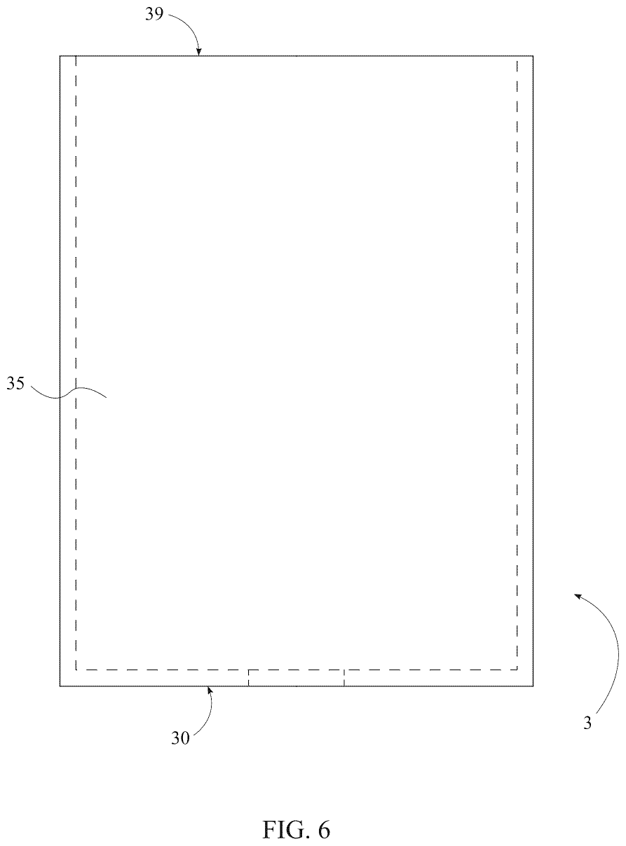

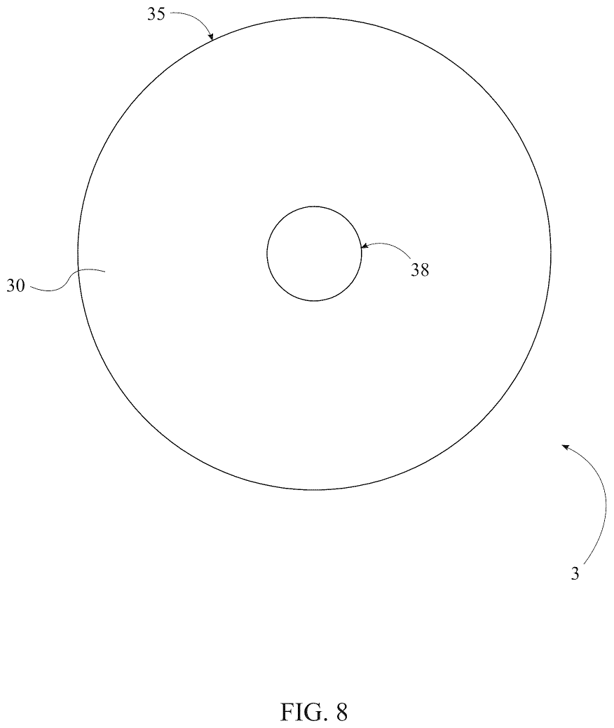

In reference to FIGS. 1-8, the present invention is an adjustable step bit 1 for drilling various size holes into a structure. The adjustable step bit 1 is designed for durability and ease of use. A core feature of the present invention is its multi-tool functionality, capable of drilling ⅞″ to 1⅜″ holes with ease. The adjustable step bit 1 comprises a plurality of hole saws 2 and a plurality of hole saw boots 3. The plurality of hole saws 2 can be of any type and can range from any standard small size to any standard large size. Each hole saw boot 3 is sized to fit firmly onto a corresponding hole saw 2. Each hole saw boot 3 is preferably manufactured from a flexible, semi-rigid material, including but not limited to silicone. The flexible material of the boot enables the first hole saw to slide firmly into place, which in turn, allows the user to drill a pilot hole without any wobble. This arrangement not only extends the lifespan of the device but also reduces the need for frequent replacements.

The hole saw boot kit is especially useful for electricians who oftentimes need to resize pass-thru holes to fit large electrical pipes. With this device, the user can begin by securing a first hole saw 21 to the front of the boot 31. The firm attachment between the boot 31 and the hole saw 21 keeps the hole saw from wobbling while drilling the pilot hole. Then, a larger hole saw 22 can be secured to the back of the boot 31 for drilling a larger hole. Additional hole saws and boots can be added as needed to widen the hole in increments until reaching the required hole size.

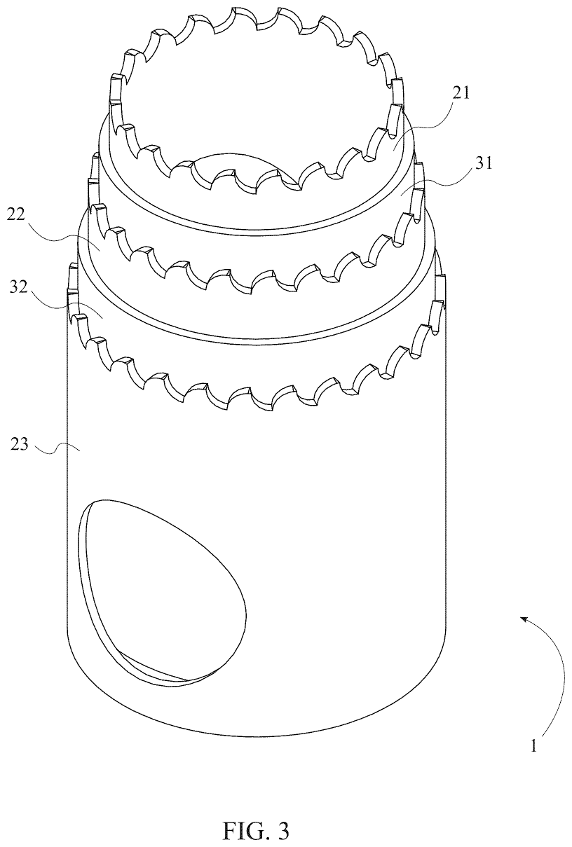

In a preferred embodiment, the plurality of hole saws 2 comprises a first hole saw 21, a second hole saw 22, and a third hole saw 23. Each of the plurality of hole saws 2 can be of any size and any type. As best seen in FIG. 3, the first hole saw 21 is smaller diameter-wise than the second hole saw 22, and the second hole saw 22 is smaller diameter-wise than the third hole saw 23. The plurality of hole saw boots 3 comprises a first hole saw boot 31 and a second hole saw boot 32. Each hole saw boot 3 is configured to fit onto a corresponding hole saw 2. This arrangement allows for stepped drilling from small to medium to large holes. In the preferred embodiment, the first hole saw 21 has a ⅞-inch outer diameter for drilling ⅞-inch holes. Here, the ⅞-inch hole functions as the pilot hole. The second hole saw 22 has a 1⅛-inch outer diameter for drilling 1⅛-inch holes. And the third hole saw 23 has a 1⅜-inch outer diameter for drilling 1⅜-inch holes. In other embodiments, the exact size of each hole saw is not limited and can be of any suitable size based on design, user, and/or manufacturing requirements.

To enable stepped drilling, the first hole saw 21 is detachably connected to the first hole saw boot 31. The first hole saw boot 31 is detachably connected to the second hole saw 22. The second hole saw 22 is detachably connected to the second hole saw boot 32. And finally, the second hole saw boot 32 is detachably connected to the third hole saw 23. Once fully assembled, the adjustable step bit 1 can be attached to the mandrel of a power tool, capable of drilling a series of holes into a structure in step increments. The user can start by drilling a pilot hole using the first hole saw 21 and then gradually widen the pilot hole in increments until reaching the desired hole diameter.

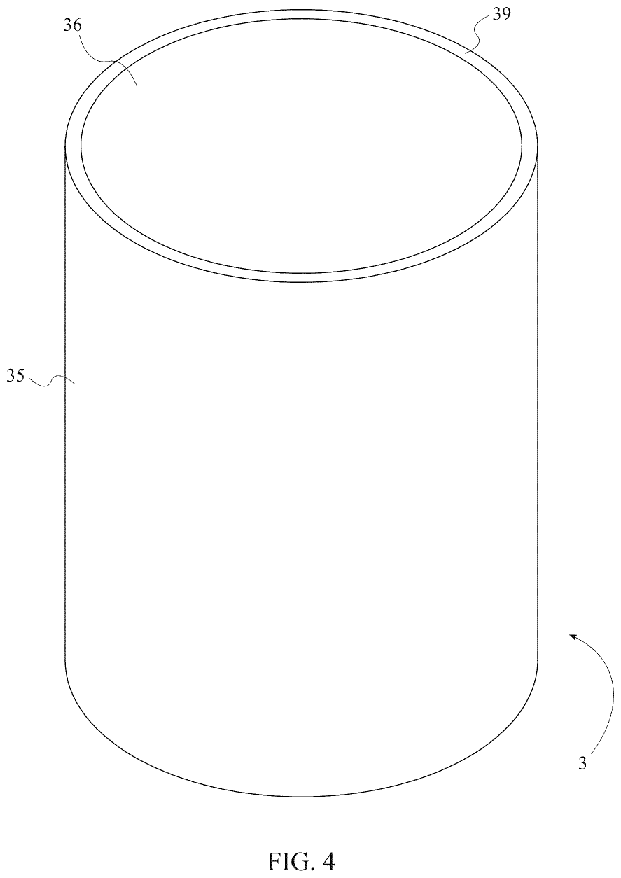

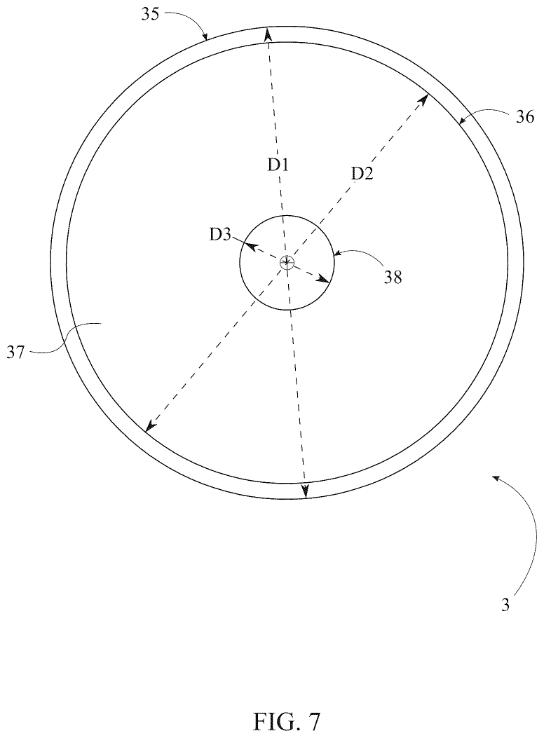

The plurality of hole saw boots 3 function as the primary components of the present invention, as the remaining hole saws 2 are configured upon the corresponding hole saw boots 3. In reference to FIGS. 4-8, each of the plurality of hole saw boots 3 comprises a cylindrical body 35, a receiver opening 36, and a base surface 37. The cylindrical body extends longitudinally from a proximal end 30 to a distal end 39. The receiver opening 36 traverses axially into the cylindrical body 35 from the distal end 39 to the base surface 37. As seen in FIG. 7, an outer diameter D1 of the cylindrical body 35 is pre-defined, delineated by the interior shape of the corresponding hole saw 2. An inner diameter D2 of the receiver opening 36 is pre-defined, delineated by the exterior shape of the corresponding hole saw 2. This arrangement provides a snug fit between each hole saw boot 3 and each corresponding hole saw 2.

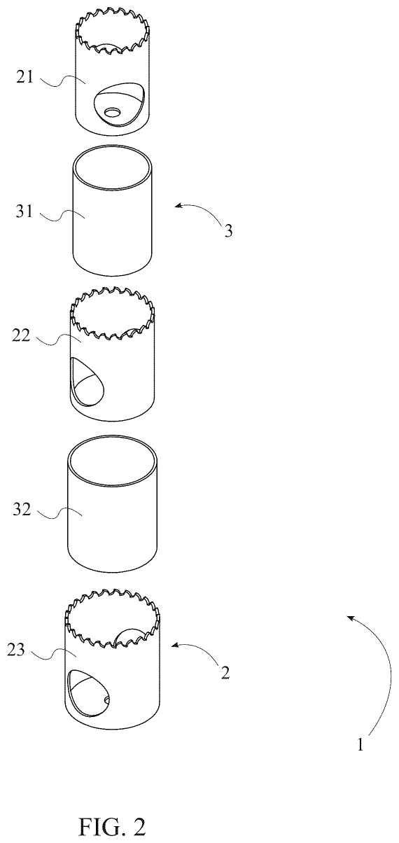

As best seen in FIG. 2, the first hole saw 21 is press-fitted into the receiver opening 36 of the first hole saw boot 31. The cylindrical body 35 of the first hole saw boot 31 is then press-fitted into the cavity of the second hole saw 22. The second hole saw 22 is then press-fitted into the receiver opening 36 of the second hole saw boot 32. And finally, the cylindrical body 35 of the second hole saw boot 32 is press-fitted into the cavity of the third hole saw 23.

Continuing with the preferred embodiment, each of the plurality of hole saw boots 3 further comprises a mounting hole 38. As best seen in FIG. 7, the mounting hole 38 traverses axially through the base surface 37. The diameter D3 of the mounting hole 38 is slightly larger than the mandrel of the power tool, thereby providing proper clearance between the mounting hole 38 and the mandrel. When attaching the adjustable step bit 1 to the power tool, the mandrel extends through the plurality of hole saw boots 3 and connects to each of the plurality of hole saws 2. Thus, when the power tool is activated, the plurality of hole saws 2 and the plurality of hole saw boots 3 all rotate together in unison. This prevents any one of the hole saws 2 from free-spinning when drilling.

Although the invention has been explained in relation to its preferred embodiment, it is to be understood that many other possible modifications and variations can be made without departing from the spirit and scope of the invention.

What is claimed is:

1. An adjustable step bit comprising:
a plurality of hole saws;
a plurality of hole saw boots;
the plurality of hole saws comprising a first hole saw and a second hole saw;
the plurality of hole saw boots comprising a first hole saw boot;
each of the plurality of hole saw boots comprising a cylindrical body, a receiver opening, a base surface, and a mounting hole;
the cylindrical body extending longitudinally from a proximal end to a distal end;
the receiver opening traversing axially into the cylindrical body from the distal end to the base surface;
the mounting hole traversing axially through the base surface;
the first hole saw being detachably connected to the first hole saw boot;
the first hole saw boot being detachably connected to the second hole saw; and
the adjustable step bit capable of drilling a series of holes into a structure in step increments.

2. The adjustable step bit as claimed in claim 1 comprising:
the first hole saw being press-fitted into the receiver opening of the first hole saw boot; and
the cylindrical body of the first hole saw boot being press-fitted into the second hole saw.

3. The adjustable step bit as claimed in claim 2 comprising:
the first hole saw having a ⅞-inch outer diameter; and
the second hole saw having a 1⅛-inch outer diameter.

4. The adjustable step bit as claimed in claim 2 comprising:
the plurality of hole saws further comprising a third hole saw;
the plurality of hole saw boots further comprising a second hole saw boot;
the second hole saw being detachably connected to the second hole saw boot; and
the second hole saw boot being detachably connected to the third hole saw.

5. The adjustable step bit as claimed in claim 4 comprising:
the second hole saw being press-fitted into the receiver opening of the second hole saw boot; and
the cylindrical body of the second hole saw boot being press-fitted into the third hole saw.

6. The adjustable step bit as claimed in claim 5, wherein the third hole saw has a 1⅜-inch outer diameter.

7. The adjustable step bit as claimed in claim 1, wherein each of the plurality of hole saw boots is made from a flexible, semi-rigid material.

8. The adjustable step bit as claimed in claim 7, wherein the flexible, semi-rigid material is silicone.

9. An adjustable step bit comprising:
a plurality of hole saws;
a plurality of hole saw boots;
the plurality of hole saws comprising a first hole saw and a second hole saw;
the plurality of hole saw boots comprising a first hole saw boot;
each of the plurality of hole saw boots comprising a cylindrical body, a receiver opening, a base surface, and a mounting hole;
the cylindrical body extending longitudinally from a proximal end to a distal end;
the receiver opening traversing axially into the cylindrical body from the distal end to the base surface;
the mounting hole traversing axially through the base surface;
each of the plurality of hole saw boots being made from a flexible, semi-rigid material;
the first hole saw being press-fitted into the receiver opening of the first hole saw boot;
the cylindrical body of the first hole saw boot being press-fitted into the second hole saw; and
the adjustable step bit capable of drilling a series of holes into a structure in step increments.

10. The adjustable step bit as claimed in claim 9 comprising:
the first hole saw having a ⅞-inch outer diameter; and
the second hole saw having a 1⅛-inch outer diameter.

11. The adjustable step bit as claimed in claim 9 comprising:
the plurality of hole saws further comprising a third hole saw;
the plurality of hole saw boots further comprising a second hole saw boot;
the second hole saw being detachably connected to the second hole saw boot; and
the second hole saw boot being detachably connected to the third hole saw.

12. The adjustable step bit as claimed in claim 11 comprising:
the second hole saw being press-fitted into the receiver opening of the second hole saw boot; and
the cylindrical body of the second hole saw boot being press-fitted into the third hole saw.

13. The adjustable step bit as claimed in claim 12, wherein the third hole saw has a 1⅜-inch outer diameter.

14. The adjustable step bit as claimed in claim 9, wherein the flexible, semi-rigid material is silicone.

15. An adjustable step bit comprising:
a plurality of hole saws;
a plurality of hole saw boots;
the plurality of hole saws comprising a first hole saw, a second hole saw, and a third hole saw;
the plurality of hole saw boots comprising a first hole saw boot and a second hole saw boot;
each of the plurality of hole saw boots comprising a cylindrical body, a receiver opening, a base surface, and a mounting hole;
the cylindrical body extending longitudinally from a proximal end to a distal end;
the receiver opening traversing axially into the cylindrical body from the distal end to the base surface;
the mounting hole traversing axially through the base surface;
each of the plurality of hole saw boots being made from a flexible, semi-rigid material;
the first hole saw being press-fitted into the receiver opening of the first hole saw boot;
the cylindrical body of the first hole saw boot being press-fitted into the second hole saw;
the second hole saw being press-fitted into the receiver opening of the second hole saw boot;
the cylindrical body of the second hole saw boot being press-fitted into the third hole saw; and
the adjustable step bit capable of drilling a series of holes into a structure in step increments.

16. The adjustable step bit as claimed in claim 15 comprising:
the first hole saw having a ⅞-inch outer diameter; and
the second hole saw having a 1⅛-inch outer diameter.

17. The adjustable step bit as claimed in claim 15, wherein the third hole saw has a 1⅜-inch outer diameter.

18. The adjustable step bit as claimed in claim 15, wherein the flexible, semi-rigid material is silicone.
